(19) United States
(12) Patent Application Publication
(10) Pub. No.: US 2025/0216299 A1
(43) Pub. Date: Jul. 3, 2025

(54) FAST LOOP FLUID SAMPLING ARRANGEMENTS

(71) Applicant: Swagelok Company, Solon, OH (US)

(72) Inventor: Matthew DIXON, Parma, OH (US)

(21) Appl. No.: 19/003,016

(22) Filed: Dec. 27, 2024

Related U.S. Application Data
(60) Provisional application No. 63/617,095, filed on Jan. 3, 2024.

(51) Int. Cl. G01N 1/20; G01N 1/10

(52) U.S. Cl. CPC G01N 1/2035; G01N 2001/105; G01N 2001/205

(57) ABSTRACT

A probe arrangement includes an elongated probe body and a fluid receiving device. The elongated probe body includes a supply passage extending axially from a distal supply port to a proximal supply port and a return passage concentrically surrounding the supply passage and extending axially from a distal return port to a proximal return port. The fluid receiving device includes a fluid receiving passage extending to a fluid receiving port, wherein the proximal return port is sealingly assembled with the fluid receiving port and the proximal supply port is in fluid communication with the fluid receiving port, such that the fluid receiving port provides a first flow path between the proximal supply port and the fluid receiving passage and a second flow path between the proximal supply port and the proximal return port.

### CROSS-REFERENCE TO RELATED APPLICATIONS

This application claims priority to U.S. Provisional Application Ser. No. 63/617,095 filed on Jan. 3, 2024, the entire disclosure of which is fully incorporated by reference herein.

### TECHNICAL FIELD

The present disclosure relates to fluid sampling systems. More particularly, the disclosure relates to fast loop fluid sampling systems.

### BACKGROUND

Sampling of liquefied gases, such as liquefied natural gas (LNG) can present multiple challenges. For example, when shipping natural gas from one location to another, it is most common to transport it in the liquified form due to the increased energy density compared to the gaseous form. To liquefy natural gas, it is first purified and then cooled down to −160° C. It can then be transported via ship from the LNG facility to ports around the world. Sampling is done when loading/unloading the LNG onto ships to measure the composition of the LNG and ultimately to determine its energy density, which dictates the commercial value of the cargo.

Because the sampled liquid is generally at low pressure and right at its boiling point, there are some common problems with LNG sampling. For example, though the LNG needs to be boiled (vaporized) to analyze it, having pre-mature boiling of the sample in the probe or transport line can compromise the representativeness of the sample, resulting in unreliable sample data. This happens when heat from the atmosphere seeps into the sample as it flows from the sample tap to the vaporizer. This heat can cause the sample to start to bubble/boil prematurely. This is typically addressed with insulation to slow heat transfer into the system from the atmosphere and/or with active cooling of the probe/transport line.

As another example, because the natural gas is analyzed in the gaseous state, and because the flow rate of gas needed for analysis is relatively low, the molecules flow through the system at a relatively low rate. However, upstream of the vaporizer, where the sample is in the liquid state, there are significantly more molecules (e.g., up to 600 times as many or more) due to the higher density of the liquid relative to the gas. As such, the liquid flow rate is significantly slower than the gas flow rate and it can take a long time for a molecule to travel through the liquid section upstream of the vaporizer. Poorly designed systems can take minutes, hours, or longer to transport a given molecule from the probe tip to the vaporizer. This may be problematic because the sample needs to be timely for effective sampling. This problem is often solved with a bypass line, where the liquid is flowed at a higher flow rate right up to the vaporizer inlet, where the bulk of the flow is then teed off and diverted to a vent system. That leaves only a small volume of transport line between the tee and the vaporizer inlet that is filled with slow-flowing LNG, thereby minimizing time delay. The downside is that the bypass flow is essentially wasted product that needs to be vented, flared, or otherwise reclaimed.

### SUMMARY OF THE DISCLOSURE

In accordance with an exemplary aspect of one or more of the inventions presented in this disclosure, a probe arrangement includes an elongated probe body and a fluid receiving device. The elongated probe body includes a supply passage extending axially from a distal supply port to a proximal supply port and a return passage concentrically surrounding the supply passage and extending axially from a distal return port to a proximal return port. The fluid receiving device includes a fluid receiving passage extending to a fluid receiving port, wherein the proximal return port is sealingly assembled with the fluid receiving port and the proximal supply port is in fluid communication with the fluid receiving port, such that the fluid receiving port provides a first flow path between the proximal supply port and the fluid receiving passage and a second flow path between the proximal supply port and the proximal return port.

In accordance with another exemplary aspect of one or more of the inventions presented in this disclosure, a fluid sampling system includes a fluid pipeline having a sample port disposed in a sidewall of the fluid pipeline, an elongated probe body removably inserted through the sample port, and a fluid receiving device including a fluid receiving passage extending to a fluid receiving port. The probe body includes a supply passage extending axially from a distal supply port within the fluid pipeline to a proximal supply port outside the fluid pipeline and a return passage extending axially from a distal return port within the fluid pipeline to a proximal return port outside the fluid pipeline. A proximal end of the elongated probe body is sealingly assembled with the fluid receiving port, such that the fluid receiving port provides a first flow path between the proximal supply port and the fluid receiving passage and a second flow path between the proximal supply port and the proximal return port. The distal supply port extends laterally from a central axis of the probe body toward an upstream end of the fluid pipeline and the distal return port extends laterally from the central axis of the probe body toward a downstream end of the fluid pipeline, such that fluid flow through the fluid pipeline from the upstream end to the downstream end generates an increased pressure in the distal supply port and a decreased pressure in the distal return port to generate fluid flow from the fluid pipeline through the first and second flow paths.

### BRIEF DESCRIPTION OF THE DRAWINGS

FIG. 1A is a schematic cross-sectional side view of an exemplary fluid sampling system, according to some aspects of the present disclosure;

FIG. 1B is a schematic cross-sectional side view of another exemplary fluid sampling system, according to some aspects of the present disclosure;

FIG. 1C is a schematic cross-sectional side view of another exemplary fluid sampling system, according to some aspects of the present disclosure;

FIG. 1D is a schematic cross-sectional side view of another exemplary fluid sampling system, according to some aspects of the present disclosure;

FIG. 2 is a perspective view of a sample probe arrangement, according to an exemplary embodiment of the present disclosure;

FIG. 3 is a perspective view of a fluid sampling system including the sample probe arrangement of FIG. 2, according to an exemplary embodiment of the present disclosure;

FIG. 4 is a cross-sectional side view of a proximal end portion of a sample probe arrangement, according to an exemplary embodiment of the present disclosure;

FIG. 5 is a cross-sectional side view of a distal end portion of a sample probe arrangement, according to an exemplary embodiment of the present disclosure;

FIG. 6 is a cross-sectional side view of a distal end portion of a sample probe arrangement inserted into a fluid pipeline, according to an exemplary embodiment of the present disclosure;

FIG. 7 is a cross-sectional side view of a distal end portion of another sample probe arrangement, according to another exemplary embodiment of the present disclosure;

FIG. 7A is a lower perspective view of the distal tip portion of the sample probe distal end portion of FIG. 7; and

FIG. 7B is an upper perspective view of the distal tip portion of the sample probe distal end portion of FIG. 7; and

FIG. 8 is a side view of another sample probe arrangement, according to another exemplary embodiment of the present disclosure, with portions of the arrangement shown in cross-section to illustrate additional features of the arrangement.

### DESCRIPTION OF THE EXEMPLARY EMBODIMENTS

This Detailed Description merely describes exemplary embodiments and is not intended to limit the scope of the claims in any way. Indeed, the invention as claimed is broader than and unlimited by the exemplary embodiments, and the terms used in the claims have their full ordinary meaning.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include the specified value, values within 5% of the specified value, and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Delays and/or fluid waste associated with fluid sampling may be reduced using a fast loop or speed loop arrangement, where the bypass flow is directed back to the process instead of to the vent system. Conventional fast loop systems utilize a pump to drive the flow, or a fluid pipeline system with an incorporated low pressure fluid return point for differential pressure driven fluid flow. Such arrangements may add cost and/or complexity to the sampling system. Additionally, for liquefied gas sampling systems, boil-off gas (BOG) generated by evaporation of the liquefied gas is relied upon to cool the incoming sample stream. This excess boil-off gas generates additional waste of process fluid.

According to exemplary aspects of the present disclosure, a fluid sampling system may utilize a sample probe arrangement having a fully contained fast loop configuration configured to be assembled directly to a sample fluid receiving/processing device (e.g., vaporizing regulator, thereby reducing time delays and minimizing sample fluid cooling requirements.

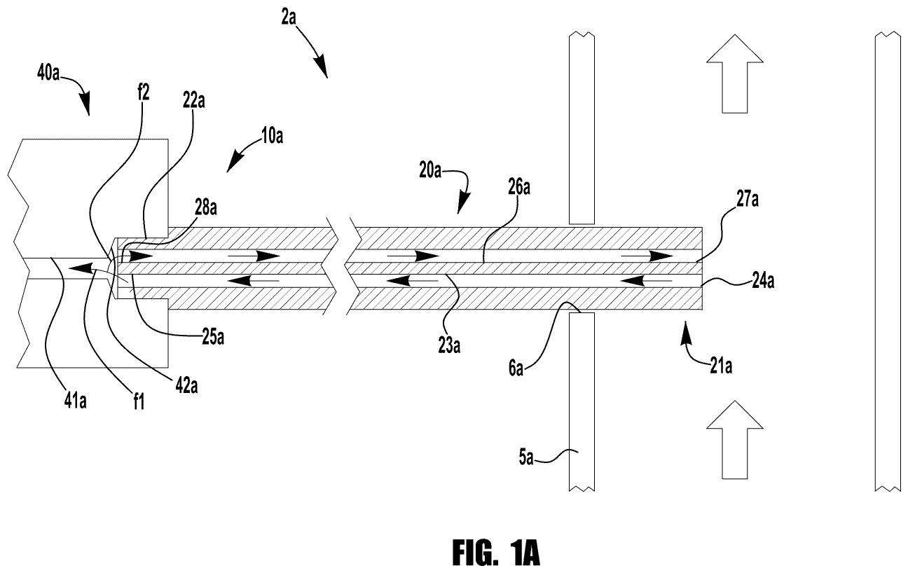

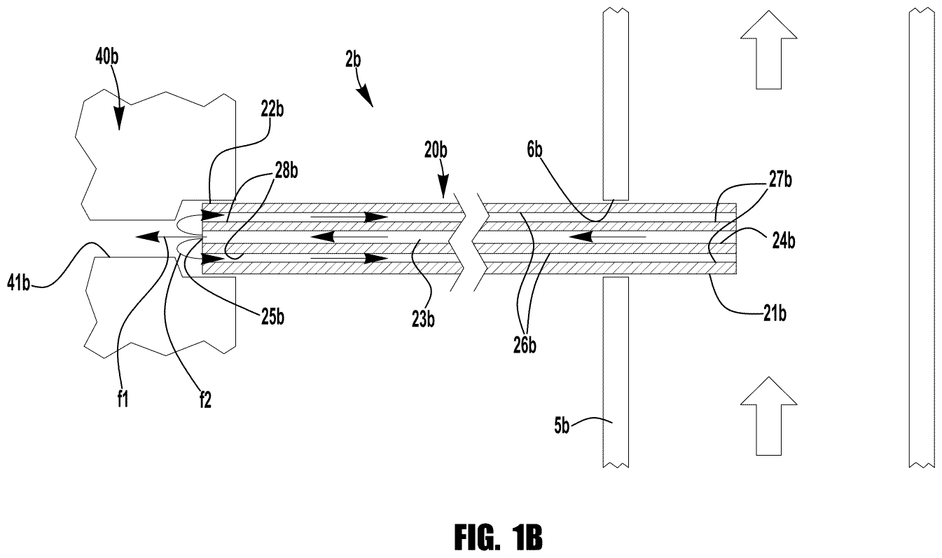

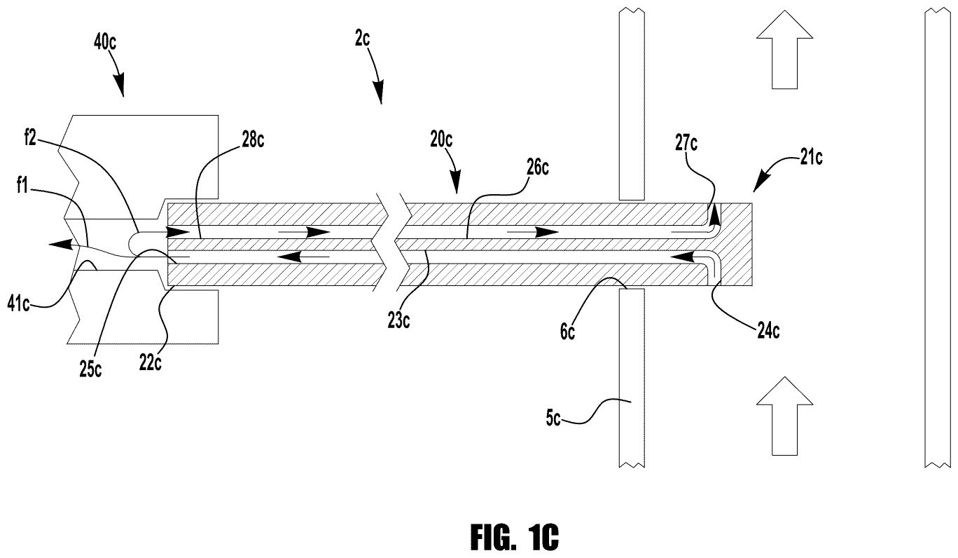

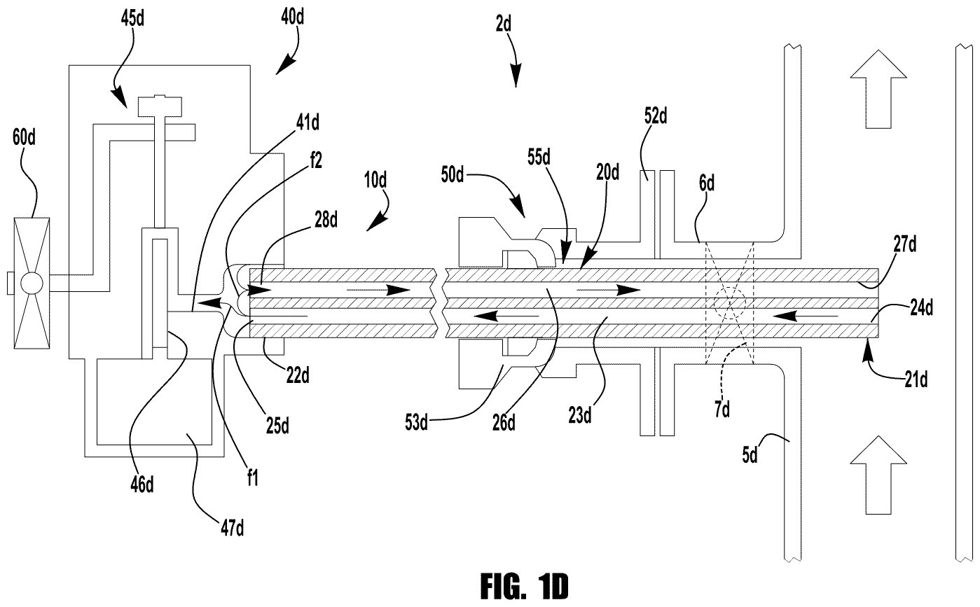

FIG. 1A schematically illustrates an exemplary fluid sampling system 2a including a sample probe arrangement 10a having an elongated sample probe body 20a and a fluid receiving device 40a. The probe body 20a has a distal end portion 21a insertable through a sample port 6a of a fluid pipeline 5a and a proximal end portion 22a assembled with the fluid receiving device 40a. The probe body 20a includes a supply passage 23a extending from a distal supply port 24a to a proximal supply port 25a and a return passage 26a extending from a distal return port 27a to a proximal return port 28a. The fluid receiving device 40a includes a fluid receiving passage 41a extending to a fluid receiving port 42a. The proximal end portion 22a of the probe body 20a is sealingly assembled with the fluid receiving port 42a, such that the fluid receiving port provides a first flow path f1 between the proximal supply port 25a and the fluid receiving passage 41a (to supply sample fluid to the fluid receiving device) and a second flow path f2 between the proximal supply port and the proximal return port 28a (to return unused/cooling extracted fluid to the fluid pipeline).

While the supply passage 23a and return passage 26a are schematically shown extending axially and parallel to each other, in other embodiments, either or both of the supply and return passages may extend in other directions, and/or form a concentric flow path arrangement, as described in greater detail herein.

While the distal supply and return ports 24a, 27a are schematically shown extending axially to the distal end of the probe body 20a, in other embodiments, either or both of the distal supply and return ports may terminate proximal to the distal end of the probe body, and/or may extend in non-axial directions, such as laterally, as described in greater detail herein.

According to other exemplary aspects of the present disclosure, a fluid sampling system may additionally or alternatively utilize a sample probe arrangement having concentric sample fluid supply and return passages, such that the bubbling/boiling return fluid in the return passage functions to cool the sample fluid in the sample passage (e.g., to prevent premature vaporization of the sample fluid), while minimizing the amount of boil-off gas necessary to sufficiently cool the sample fluid.

FIG. 1B schematically illustrates an exemplary fluid sampling system 2b including a sample probe arrangement 10b (which may, but need not, include additional features common to one or more of the features of the sample probe arrangement 10a of FIG. 1A). The sample probe arrangement 10b includes an elongated sample probe body 20b and a fluid receiving device 40b. The probe body 20b has a distal end portion 21b insertable through a sample port 6b of a fluid pipeline 5b and a proximal end portion 22b assembled with the fluid receiving device 40b. The probe body 20b includes a supply passage 23b extending from a distal supply port 24b to a proximal supply port 25b and a return passage 26b concentrically surrounding the supply passage 23b and extending from a distal return port 27b to a proximal return port 28b. The fluid receiving device 40b includes a fluid receiving passage 41b. The sample probe arrangement 10b is configured to provide a first flow path f1 between the proximal supply port 25b and the fluid receiving passage 41b (to supply sample fluid to the fluid receiving device) and a second flow path f2 between the proximal supply port and the proximal return port 28b (to return unused/cooling extracted fluid to the fluid pipeline). In other embodiments, the supply passage may concentrically surround the return passage.

While the supply passage 23b and return passage 26b are schematically shown extending axially, in other embodiments, either or both of the supply and return passages may extend in other directions.

While the distal supply and return ports 24b, 27b are schematically shown extending axially to the distal end of the probe body 20b, in other embodiments, either or both of the distal supply and return ports may terminate proximal to the distal end of the probe body, and/or may extend in non-axial directions, such as laterally, as described in greater detail herein.

According to other exemplary aspects of the present disclosure, a fluid sampling system may additionally or alternatively utilize a sample probe arrangement having a fluid pipeline inserted distal end of the sample probe including an upstream facing distal supply port and a downstream facing distal return port. In such an arrangement, the laterally extending distal supply and return ports may be configured to function as pitot tubes, using the Bernoulli effect to generate a pressure differential sufficient to drive fluid flow through the fast loop configuration of the sample probe arrangement. The dynamic pressure of the pipeline fluid flow velocity generates an increased pressure at the upstream facing distal supply port and a reduced pressure or suction at the downstream facing distal return port, resulting in a differential pressure between the fluid supply channel and the fluid return channel, sufficient to drive fluid flow through the fast loop configuration of the sample probe arrangement. In some such embodiments, this differential pressure flow generation may eliminate the need for a pump to drive fluid flow, or at least reduce any required pump output.

FIG. 1C schematically illustrates an exemplary fluid sampling system 2c including a sample probe arrangement 10c (which may, but need not, include additional features common to one or more of the features of the sample probe arrangements 10a, 10b of FIGS. 1A and 1B). The sample probe arrangement 10c includes an elongated sample probe body 20c and a fluid receiving device 40c. The probe body 20c has a distal end portion 21c insertable through a sample port 6c of a fluid pipeline 5c and a proximal end portion 22c assembled with the fluid receiving device 40c. The probe body 20c includes a supply passage 23c extending from an upstream facing distal supply port 24c to a proximal supply port 25c and a return passage 26c extending from a downstream facing distal return port 27c to a proximal return port 28c. The fluid receiving device 40c includes a fluid receiving passage 41c. The sample probe arrangement 10c is configured to provide a first flow path f1 between the proximal supply port 25c and the fluid receiving passage 41c (to supply sample fluid to the fluid receiving device) and a second flow path f2 between the proximal supply port and the proximal return port 28c (to return unused/cooling extracted fluid to the fluid pipeline).

While the supply passage 23c and return passage 26c are schematically shown extending axially and parallel to each other, in other embodiments, either or both of the supply and return passages may extend in other directions, and/or form a concentric flow path arrangement, as described in greater detail herein.

While the distal supply and return ports 24c, 27c are schematically shown extending axially to the distal end of the probe body 20c, in other embodiments, either or both of the distal supply and return ports may terminate proximal to the distal end of the probe body, as described in greater detail herein.

According to other exemplary aspects of the present disclosure, a fluid sampling system may additionally or alternatively be configured such that the sample probe arrangement is easily retracted from a fluid pipeline, for example, without requiring prolonged shutdown of the fluid pipeline or disassembly of the sample probe arrangement. For example, the sample probe arrangement may include a probe body insertable through a probe body sealing coupling and into a sample port in the fluid pipeline. As another example, the sample probe arrangement may include a self-contained assembly or unit having a sample probe body assembled to a vaporizing regulator for ease of retraction and removal (e.g., for cleaning and/or maintenance) of the sample probe arrangement.

FIG. 1D schematically illustrates an exemplary fluid sampling system 2d including a sample probe arrangement 10d (which may, but need not, include additional features common to one or more of the features of the sample probe arrangements 10a, 10b, 10c of FIGS. 1A, 1B, and 1C). The sample probe arrangement 10d includes an elongated sample probe body 20d and a fluid receiving device 40d (e.g., a vaporizing regulator). The probe body 20d has a distal end portion 21d insertable through a sample port 6d of a fluid pipeline 5d and a proximal end portion 22d assembled with the fluid receiving device 40d. The probe body 20d includes a supply passage 23d extending from a distal supply port 24d to a proximal supply port 25d and a return passage 26d extending from a distal return port 27d to a proximal return port 28d. The fluid receiving device 40d includes a fluid receiving passage 41d. The sample probe arrangement 10d is configured to provide a first flow path f1 between the proximal supply port 25d and the fluid receiving passage 41d (to supply sample fluid to the fluid receiving device) and a second flow path f2 between the proximal supply port and the proximal return port 28d (to return unused/cooling extracted fluid to the fluid pipeline).

While the supply passage 23d and return passage 26d are schematically shown extending axially and parallel to each other, in other embodiments, either or both of the supply and return passages may extend in other directions, and/or form a concentric flow path arrangement, as described in greater detail herein.

While the distal supply and return ports 24d, 27d are schematically shown extending axially to the distal end of the probe body 20d, in other embodiments, either or both of the distal supply and return ports may terminate proximal to the distal end of the probe body, and/or may extend in non-axial directions, such as laterally, as described in greater detail herein.

As shown, the probe body 20d may be insertable through a through bore 55d in a probe body sealing coupling 50d and into the sample port 6d in the fluid pipeline 5d. The probe body sealing coupling 50d may be integrally formed with the sample port 6d, or may be provided with a first connection (e.g., ANSI flange) 52d sealingly assembled with the sample port 6d (e.g., with an ANSI flange or other connection on the sample port) and a second connection (e.g., compression seal fitting) 53d sealingly assembled with or installed on an outer surface of the probe body 20d to provide an external steal between the fluid pipeline 5d and the probe body, for example, to provide a leak tight seal around the inserted probe body. The sample port 6d may be provided with an isolation valve 7d (e.g., ball valve) operable between an open position for insertion of the probe body 20d therethrough and a closed position sealingly containing the pipeline fluid when the probe body is retracted.

As shown, the sample probe arrangement may be provided as a self-contained assembly or unit having a sample probe body 20d assembled to a vaporizing regulator 45d (defining at least a portion of the fluid receiving device 40d) for ease of retraction and removal (e.g., for cleaning and/or maintenance) of the sample probe arrangement 10d from the fluid pipeline 5d. The vaporizing regulator 45d may include a heating element 46d to facilitate full vaporization of the sample fluid received in the fluid receiving passage 41d, with a junction box 47d managing power to the heating element. A shutoff valve 60d (e.g., needle valve) may be connected to a downstream port of the regulator 45d, for example, to control flow of the vaporized fluid to analysis equipment.

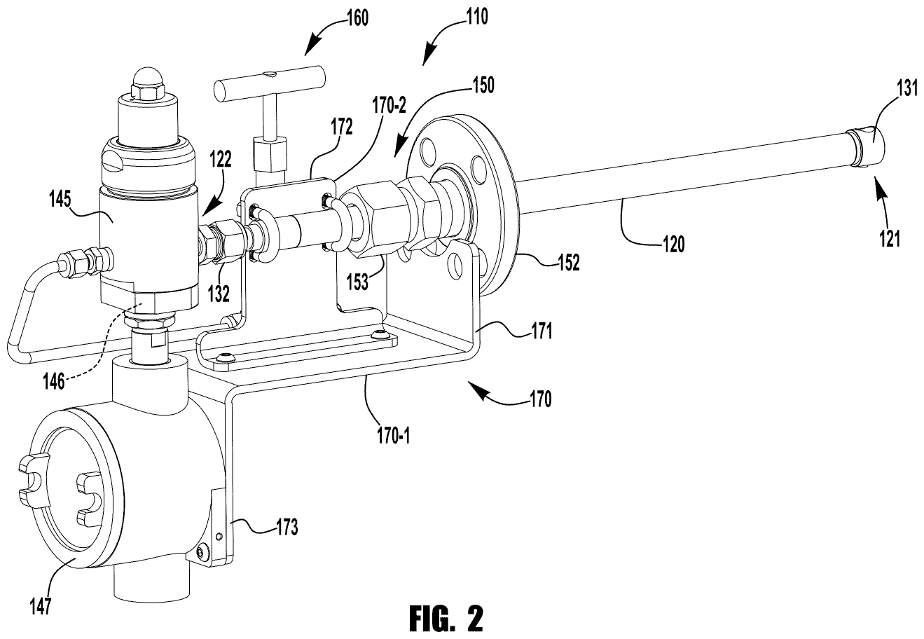

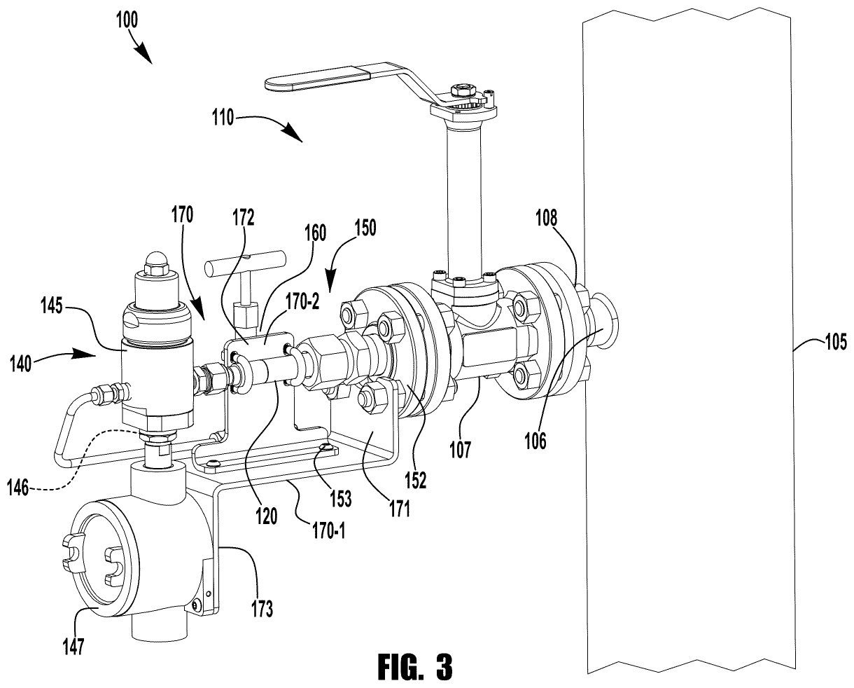

FIGS. 2 and 3 illustrate an exemplary embodiment of a sample probe arrangement 110 including an elongated probe body 120 and a fluid receiving device 140 (in the illustrated embodiment, a vaporizing regulator). The probe body 120 includes a distal end portion 121 insertable through a sample port 106 of a fluid pipeline 105 (FIG. 3) and a proximal end portion 122 assembled with the vaporizing regulator 140.

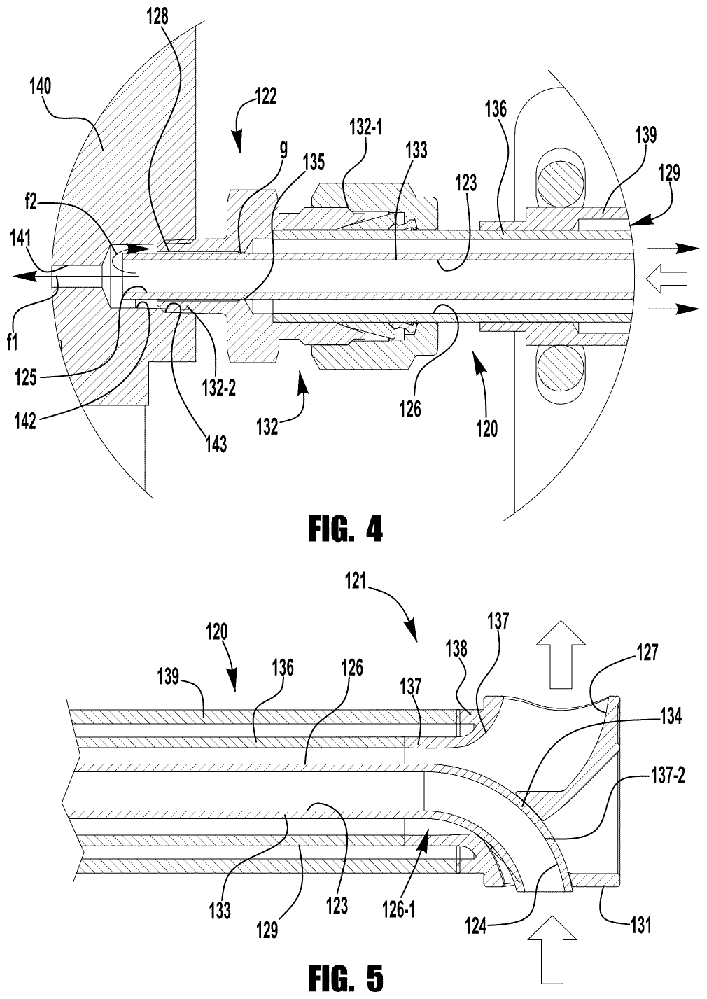

FIGS. 4 and 5 illustrate cross-sectional views of proximal and distal end portions 122, 121 of an exemplary fast loop configuration for the probe body 120. As shown, the probe body 120 includes a supply passage 123 extending from a distal supply port 124 to a proximal supply port 125 and a return passage 126 extending from a distal return port 127 to a proximal return port 128. The vaporizing regulator 140 includes a fluid receiving passage 141 extending to a fluid receiving port 142. The proximal end portion 122 of the probe body 120 is sealingly assembled with the fluid receiving port 142 (e.g., by a threaded connection, e.g., NPT threads), such that the fluid receiving port provides a first flow path f1 between the proximal supply port 125 and the fluid receiving passage 141 (to supply sample fluid to the fluid receiving device) and a second flow path f2 between the proximal supply port and the proximal return port 128 (to return unused/cooling extracted fluid to the fluid pipeline).

The supply passage 123 and return passage 126 may be sized and oriented in a variety of configurations, including, for example, parallel axial passages or concentric passages. In the illustrated embodiment, the supply passage 123 is defined by an inner tube portion or supply tube 133 extending along a central axis of the probe body 120, and the return passage 126 is defined by an outer tube portion or return tube 136 concentrically surrounding the inner tube portion 133, such that the return passage 126 is an annular passage that surrounds the supply passage. In such an arrangement, the bubbling/boiling return fluid in the return passage 126 functions to cool the sample fluid in the sample passage 123 (e.g., to prevent premature vaporization of the sample fluid). In other embodiments, the supply passage may concentrically surround the return passage.

As shown, the probe body 120 may additionally include an annular insulation cavity 129 surrounding at least a portion of the outer tube portion 136, for example, to function as an insulating layer for minimizing heat transfer between the atmosphere and the annular return passage 126, thereby promoting heat transfer from the supply passage 123 to the return passage. The insulating cavity 129 may contain air, or some other insulating fluid (e.g., argon) or material, or may be maintained at a vacuum, to provide enhanced insulation. In the illustrated embodiment, the insulating cavity 129 is defined by an exterior tube portion or insulating tube 139 concentrically surrounding the outer tube portion 136, such that the insulating cavity 129 is an annular cavity that surrounds the return passage 126. While many different size tube portions may be utilized, in an exemplary embodiment, the inner tube portion has a ¼ inch outer diameter, the outer tube portion has a ½ inch outer diameter, and the exterior tube portion has a ¾ inch outer diameter.

The connection between the probe body proximal end portion 122 and the vaporizing regulator may be effected using a variety of configurations, including, for example, configurations completing the fluid fast loop through the sample probe arrangement. In the illustrated embodiment, as shown in FIG. 4, the proximal end 122 of the sample probe body 120 includes a coupling 132 having a first end connection (e.g., tube fitting, such as, for example, a two ferrule tube fitting, as shown) 132-1 assembled in sealing engagement with a proximal end of the outer tube portion 136, and a second end connection (e.g., male threaded NPT connection) 132-2 assembled in sealing engagement with a corresponding connection (e.g., female threaded NPT connection) 143 on the fluid receiving port 142.

The coupling 132 includes a through bore 135 sized to provide an annular gap or orifice g surrounding the inner tube portion 133, to define a portion of the annular return passage 126. This annular gap g may be closely controlled, for example, to provide a desired or self-regulating pressure drop in the fast loop, the pressure drop being configured to encourage bubbling/boiling of the liquefied gas as the liquefied gas is returned to the fluid pipeline at a reduced pressure. Because this boiling process requires external energy, heat is drawn from the liquefied gas in the supply passage 123, thereby preventing premature vaporization of the fluid in the supply passage.

As shown, the inner tube portion 133 extends beyond the coupling 132 into the fluid receiving port 142 and terminates at a location spaced apart from the fluid receiving passage 141. In this configuration, the fluid receiving port 142 provides a first flow path between the proximal supply port 123 and the fluid receiving passage 141 and a second flow path between the proximal supply port 123 and the proximal return port 126.

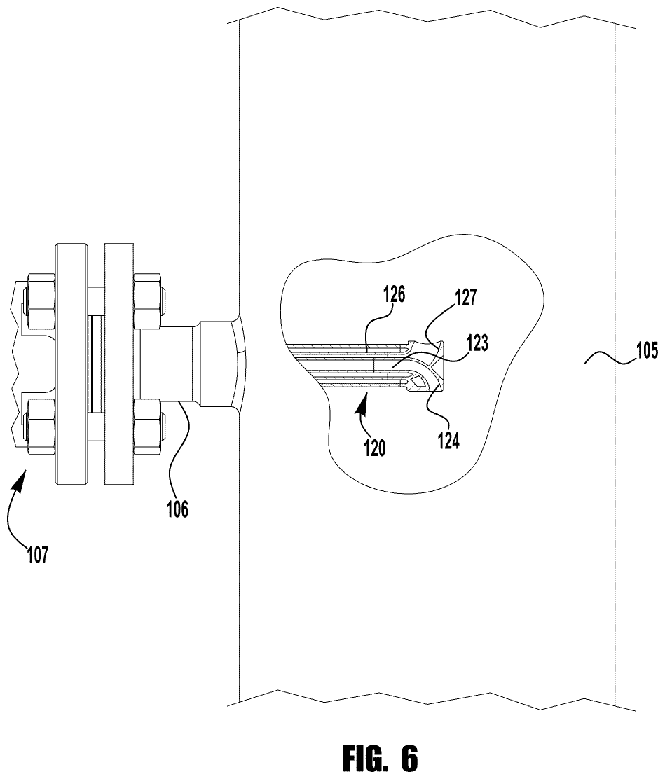

The distal supply and return ports may be provided in a variety of arrangements and configurations, including, for example, axially facing and laterally facing ports. In the illustrated embodiment, as shown in FIG. 5, the distal end portion 121 of the probe body 120 includes opposed laterally extending distal supply and return ports 124, 127, such that the probe body 120 may be oriented with respect to the fluid pipeline 105 to direct the distal supply port toward the upstream end of the fluid pipeline and the distal return port toward the downstream end of the fluid pipeline, as shown in FIG. 6. In such an arrangement, the laterally extending distal supply and return ports 124, 127 may be configured to function as pitot tubes, using the Bernoulli effect to generate a pressure differential sufficient to drive fluid flow through the fast loop configuration of the sample probe arrangement, wherein the forward pitot tube (supply port) generates increased pressure P_{F}=P_{S}+½ρV² and the reverse pitot tube (return port) generates decreased pressure P_{R}=P_{S}−½ρV², with the total differential pressure being independent of line pressure ΔP=P_{F}−P_{R}=(P_{S}+½ρV²)−(P_{S}−½ρV²)=ρV², in which P_{S}=Static Pressure (Pa), ρ=Fluid Density (kg/m³), and V=Pipeline Velocity (m/s).

To provide laterally extending distal supply and return ports 124, 127 extending from concentric axial supply and return passages 123, 126, the inner supply passage extends through a side wall of the outer return passage. Many different structural arrangements and fabrication methods may be utilized to provide concentric supply and return passages with laterally extending distal supply and return ports as contemplated by the present disclosure. In the illustrated embodiment, as shown in FIG. 5, the distal end portion 121 of the probe body 120 includes a probe tip 131 having an inner wall portion 137 that defines the laterally extending distal return port 127 and a distal portion 126-1 of the return passage 126 extending to a tube stub 137-1 for attachment (e.g., welding, brazing) to the outer tube portion 136. The probe tip inner wall portion 137 includes an aperture 137-2 that receives the laterally extending distal supply port 124 therethrough. To construct the complex shape of the probe tip 131, additive manufacturing (e.g., 3D printing) may be utilized to form all or part of the probe tip. In some implementations, the inner bore surfaces of the inner tube portion 133 may be provided with a superior (e.g., smoother) surface finish compared that the internal surfaces of the probe tip 131, for example, to minimize contamination of the extracted sample fluid on the supply side of the fast loop configuration.

In an exemplary method of fabricating the probe body 120, an inner tube portion 133, provided with a bent end portion 134 defining the distal supply port 124, is inserted into the inner wall portion 137 of probe tip 131, with the bent end portion inserted through the inner wall aperture 137-2 and the proximal (non-bent) portion of the inner tube portion 133 being pivoted into concentric axial alignment with the distal portion 126-1 of the return passage 126. The outer tube portion 136 is then attached (e.g., welded, brazed) to the inner wall tube stub 137-1 to concentrically surround the inner tube portion 133 and define the annular return passage 126. In embodiments utilizing an annular insulating cavity 129 around the return passage 126, as shown, the exterior tube portion 139 is then attached (e.g., welded, brazed) to an exterior tube stub 138 surrounding the inner wall tube stub 137-1 to concentrically surround the outer tube portion 136 and define the annular insulating cavity 129. As shown, the inner wall tube stub 137-1 may extend beyond the exterior tube stub 138, for example, to facilitate sequential welding operations.

While a seal may be provided between the bent end portion 134 of the inner tube portion 133 and the inner wall portion 137 at the aperture 137-2, in some embodiments, a small gap may be permitted, as any fluid flow through such a gap may be inconsequential in its effects on directing fast loop fluid flow through the sample probe arrangement.

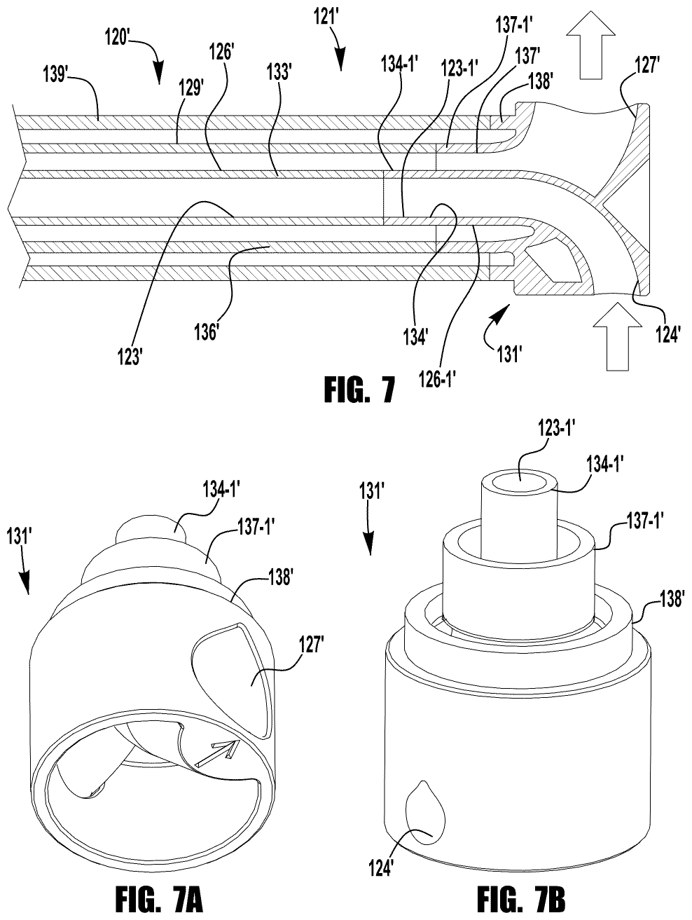

In other embodiments, a probe body may be provided with a unitary probe tip that includes the distal sample port and a distal portion of the supply passage. FIG. 7 illustrates a distal end portion 121′ of an exemplary probe body 120′ including a probe tip 131′ having a first inner wall portion 134′ that defines the laterally extending distal supply port 124′ and a distal portion 123-1′ of the supply passage 123′ extending to a tube stub 134-1′ for attachment (e.g., welding, brazing) to the inner tube portion 133′, and a second inner wall portion 137′ that defines the laterally extending distal return port 127′ and a distal portion 126-1′ of the return passage 126′ extending to a tube stub 137-1′ for attachment (e.g., welding, brazing) to the outer tube portion 136′. The probe tip first inner wall portion 134′ extends laterally through the second inner wall portion 137′. To construct the complex shape of the probe tip 131′, additive manufacturing (e.g., 3D printing) may be utilized to form all or part of the probe tip. Certain aspects of the probe tip may be adapted to facilitate additive manufacturing of the component, such as for example, providing the distal supply and return ports 124′, 127′ in a teardrop shape, as sown in the perspective views of FIGS. 7A and 7B.

In an exemplary method of fabricating the probe body 120′, an inner tube portion 133′ is attached (e.g., welded, brazed) to the first inner wall tube stub 134-1′. The outer tube portion 136′ is then attached (e.g., welded, brazed) to the second inner wall tube stub 137-1′ to concentrically surround the inner tube portion 133′ and define the annular return passage 126′. In embodiments utilizing an annular insulating cavity 129′ around the return passage 126′, as shown, the exterior tube portion 139′ is then attached (e.g., welded, brazed) to an exterior tube stub 138′ surrounding the second inner wall tube stub 137-1′ to concentrically surround the outer tube portion 136′ and define the annular insulating cavity 129′. As shown, the second inner wall tube stub 137-1′ may extend beyond the exterior tube stub 138′ and the first inner wall tube stub 134-1′ may extend beyond the second inner wall tube stub 137-1′, for example, to facilitate sequential welding operations.

While the probe body may be more permanently assembled or installed with the fluid pipeline (e.g., by welding or brazing, or by other direct assembly of the probe body to the fluid pipeline), in other arrangements, the fluid sampling system may be configured to facilitate retraction of the sample probe arrangement from the fluid pipeline, for example, for cleaning or maintenance of the sample probe arrangement.

Referring back to FIGS. 2 and 3, the fluid sampling system 100 may be configured such that the probe body 120 of the exemplary sample probe arrangement 110 is retractably insertable through a through bore 155 in a probe body sealing coupling 150 and into a sample port 106 in the fluid pipeline 105. The sample port 106 includes an isolation valve 107 (e.g., ball valve) secured to a conduit extension 108 of the sample port (e.g., by ANSI flange connections, as shown) and operable between an open position for insertion of the probe body 120 therethrough and a closed position sealingly containing the pipeline fluid when the probe body is retracted. While the probe body sealing coupling 150 may be integrally formed with the sample port 106 (e.g., integrally formed with the body of the isolation valve 107), in the illustrated embodiment, the probe body sealing coupling is provided with a first connection (e.g., ANSI flange, as shown) 152 sealingly assembled with the sample port 106 (e.g., with an ANSI flange end connection of the isolation valve 107) and a second connection 153 (e.g., compression seal fitting, for example, an HPG compression seal fitting, manufactured by Conax Technologies) sealingly assembled with or installed on an outer surface of the probe body 120 to provide an external steal between the fluid pipeline 105 and the probe body, for example, to provide a leak tight seal around the inserted probe body.

As shown, the sample probe arrangement 110 may be provided as a self-contained assembly or unit having a sample probe body 120 assembled to a vaporizing regulator 145 (defining at least a portion of the fluid receiving device 140) for ease of retraction and removal (e.g., for cleaning and/or maintenance) of the sample probe arrangement 110 from the fluid pipeline 105. The vaporizing regulator 145 (e.g., a KEV regulator, manufactured by Swagelok Co.) may include a heating element 146 to facilitate full vaporization of the sample fluid received in the fluid receiving passage 141, with a junction box 147 managing power to the heating element. A shutoff valve 160 (e.g., needle valve) may be connected to a downstream port of the regulator 145, for example, to control flow of the vaporized fluid to analysis equipment.

To retain the components of the sample probe arrangement together, a bracket or other such support structure may be proved for attachment to the sample probe body, probe body sealing coupling, fluid receiving device, and shutoff valve. In the illustrated embodiment, the sample probe arrangement 110 includes a bracket 170 having a first flange 171 secured to the first connection 152 of the probe body sealing coupling 150 (e.g., by nuts tightened to the lower ANSI flange stud bolts), a second flange 172 secured to the probe body 120 (e.g., by threaded U-bolts, as shown) and to the shutoff valve 160 (e.g., by fasteners installed with the shutoff valve body), and a third flange 173 secured to the fluid receiving device 140 (e.g., by fasteners installed with the junction box 147 of the vaporizing regulator 145). In the illustrated embodiment, the bracket 170 includes two bracket elements 170-1, 170-2 secured together (e.g., by fasteners). In other embodiments, the bracket may be a single component or may be formed by more than two bracket elements. In still other embodiments, a housing or other such structure may be used to retain the sample probe arrangement components.

In an exemplary implementation, to retract the probe body 120 from the fluid pipeline 105, the first bracket flange 171 is detached from the first (ANSI) connection of the probe body sealing coupling 150 and the compression seal fitting connection 153 of the probe body sealing coupling 150 is loosened (to the extent necessary to permit sliding movement of the probe body 120, potentially without compromising the seal around the probe body). The sample probe arrangement 110 is then moved axially away from the fluid pipeline 105, such that the distal end 121 of the probe body 120 is withdrawn from the fluid pipeline and from the internal valve element (e.g., ball element, not shown) of the isolation valve 107, and the isolation valve is operated to the closed position. The sample probe arrangement may then be fully removed from the pipeline 105 and probe body sealing coupling 150, for example, for cleaning and/or maintenance.

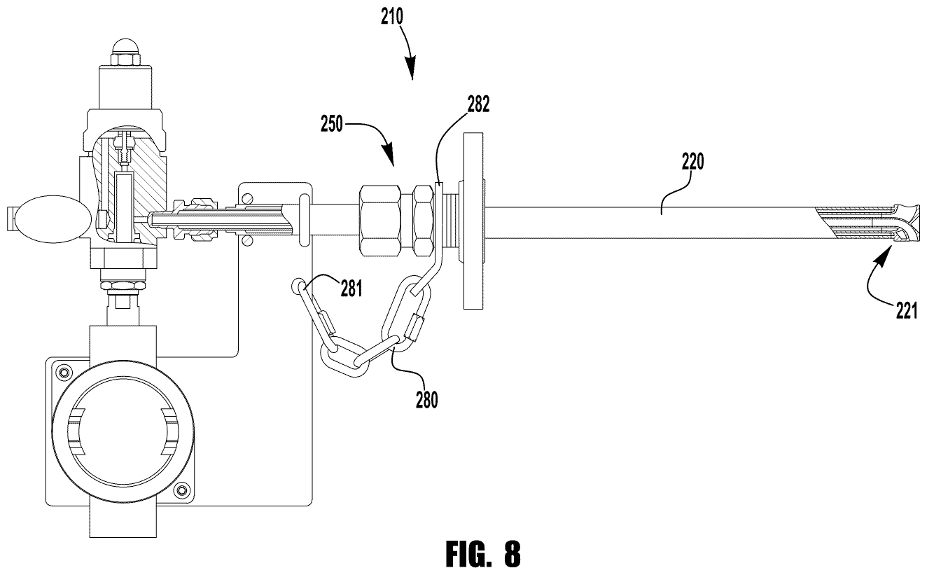

In some embodiments, a sample probe arrangement may be tethered or otherwise constricted to limit withdrawal of the probe body from the sample port and/or probe body sealing coupling. In the exemplary embodiment of FIG. 8, the sample probe arrangement 210 is tethered to the probe body sealing coupling 250 by a chain 280 (although any suitable flexible cord or cable may be used) having a first end 281 secured to the sample probe arrangement (e.g., to the bracket 270, as shown) and a second end 282 secured to the probe body sealing coupling. The length of the chain may be selected to permit and/or gauge withdrawal of the distal end 221 of the probe body 220 from the valve element of the isolation valve (not shown) while preventing further withdrawal of the probe body.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

We claim:

1. A sample probe arrangement comprising:
an elongated probe body including a supply passage extending axially from a distal supply port to a proximal supply port and a return passage concentrically surrounding the supply passage and extending axially from a distal return port to a proximal return port; and
a fluid receiving device including a fluid receiving passage extending to a fluid receiving port, wherein the proximal return port is sealingly assembled with the fluid receiving port and the proximal supply port is in fluid communication with the fluid receiving port, such that the fluid receiving port provides a first flow path between the proximal supply port and the fluid receiving passage and a second flow path between the proximal supply port and the proximal return port.

2. The sample probe arrangement of claim 1, wherein the proximal supply port extends beyond the proximal return port and into the fluid receiving port.

3. The sample probe arrangement of claim 1, wherein the probe body includes a return tube defining the return passage.

4. The sample probe arrangement of claim 3, wherein the probe body includes a tube fitting assembled with a proximal end of the return tube, the tube fitting having a proximal end defining the proximal return port.

5. The sample probe arrangement of claim 3, wherein the probe body includes a probe tip welded to the return tube, wherein the probe tip defines the distal return port.

6. The sample probe arrangement of claim 1, wherein the probe body includes a supply tube defining the supply passage.

7. The sample probe arrangement of claim 1, wherein the distal supply port extends laterally from a central axis of the probe body.

8. The sample probe arrangement of claim 1, wherein the distal return port extends laterally from a central axis of the probe body.

9. The sample probe arrangement of claim 1, wherein the distal supply port extends through a side wall of the return passage.

10. The sample probe arrangement of claim 1, wherein the distal return port extends laterally from a central axis of the probe body in a first direction and the distal supply port extends laterally from the central axis of the probe body in a second direction opposite the first direction.

11. The sample probe arrangement of claim 1, wherein the probe body includes an annular insulating cavity concentrically surrounding the return passage.

12. The sample probe arrangement of claim 1, wherein the fluid receiving device comprises a vaporizing regulator operable to vaporize liquefied natural gas fluid supplied to the fluid receiving passage.

13. A fluid sampling system comprising:
a fluid pipeline including a sample port disposed in a sidewall of the fluid pipeline;
an elongated probe body removably inserted through the sample port and including a supply passage extending axially from a distal supply port within the fluid pipeline to a proximal supply port outside the fluid pipeline and a return passage extending axially from a distal return port within the fluid pipeline to a proximal return port outside the fluid pipeline;
a fluid receiving device including a fluid receiving passage extending to a fluid receiving port, wherein a proximal end of the elongated probe body is sealingly assembled with the fluid receiving port, such that the fluid receiving port provides a first flow path between the proximal supply port and the fluid receiving passage and a second flow path between the proximal supply port and the proximal return port;
wherein the distal supply port extends laterally from a central axis of the probe body toward an upstream end of the fluid pipeline and the distal return port extends laterally from the central axis of the probe body toward a downstream end of the fluid pipeline, such that fluid flow through the fluid pipeline from the upstream end to the downstream end generates an increased pressure in the distal supply port and a decreased pressure in the distal return port to generate fluid flow from the fluid pipeline through the first and second flow paths.

14. The fluid sampling system of claim 13, wherein the return passage concentrically surrounds the supply passage.

15. The fluid sampling system of claim 13, wherein the proximal return port is sealingly assembled with the fluid receiving port and the proximal supply port is in fluid communication with the fluid receiving port.

16. The fluid sampling system of claim 13, wherein the probe body includes an annular insulating cavity concentrically surrounding the return passage.

17. The fluid sampling system of claim 13, wherein the sample port comprises an isolation valve, wherein the probe body is insertable and retractable through the isolation valve when the isolation valve is in an open condition.

18. The fluid sampling system of claim 13, further comprising a coupling having a through bore receiving the probe body therethrough, the coupling having a first connection sealingly assembled with the sample port and a second connection sealingly assembled with an outer surface of the probe body to provide an external seal between the fluid pipeline and the probe body.

19. The fluid sampling system of claim 18, wherein the first connection comprises an ANSI flange.

20. The fluid sampling system of claim 18, wherein the second connection comprises a compression seal fitting.
